(19) United States
(12) Patent Application Publication
(10) Pub. No.: US 2006/0182416 A1
(43) Pub. Date: Aug. 17, 2006

(54) Subtitle scrolling detecting device and method

(76) Inventors: Wang Jiunn Shyang, Hsin-Tien City (TW); Cho Yi Lin, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/125,233

(22) Filed: May 10, 2005

(30) Foreign Application Priority Data
Feb. 15, 2005 (TW) 094104360

(51) Int. Cl. H04N 7/52

(52) U.S. Cl. 386/95

(57) ABSTRACT

The real time scrolling subtitle detecting device and method which includes a subtitle decoding unit to decode a subtitle stream for obtaining a first compressed subtitle data and a second compressed subtitle data and generating a first subtitle data and a second subtitle data corresponding to the first and the second compressed subtitle respectively, a receiving unit to receive the first compressed subtitle data and the second one of the subtitle decoding unit, and a detecting module to detect and obtain an offset of the first compressed subtitle data and the second one to determine a subtitle scrolling information of the second subtitle data.

### BACKGROUND OF THE INVENTION

1. Field of Invention

The present invention relates to a scrolling subtitle detecting device and method and, in particular, to the device and method which obtains a subtitle scrolling information through detecting a first compressed subtitle data and a second compressed subtitle data.

2. Related Art

The information technology improvement results from some factors such as the living standard progression recently, and the research and development trend of the information product for the audio/video player and relative effects especially become a critical point.

Generally, the most common video effect is subtitle effect, and especially the subtitle scaling up and down. However, since the subtitle data stream is encoded in a variable length encoding technique and the decoded subtitle data includes several lines of the block data, the audio/video player will delete block data of the fixed position and scaling up width and height of the remained block data while the subtitle with both scrolling and scaling effect, and hence the deleted block data will be displayed in the frame so that the unexpected subtitle serration appears.

Moreover, since the life cycle shortening and developing period become the essential consideration of product development, most the enterprises are seeking the efficient way to provide more services and better products for consumer demand satisfaction.

Accordingly, elimination of the playing delay resulted from subtitle scrolling and the subtitle serration resulted from the display of the deleted block data on the frame in performing both the subtitle scrolling and scaling effect simultaneously through the real time scrolling information detecting and obtaining device and method is a research aspect of the mentioned problem.

### SUMMARY OF THE INVENTION

In view of the foregoing, the invention is to provide a real time scrolling subtitle detecting device and method which the device includes a subtitle decoding unit, a receiving unit, and a detecting module. Herein, the subtitle decoding unit decodes a subtitle stream to obtain a first compressed subtitle data and a second one, and then generates a first subtitle data corresponding to the first compressed subtitle data and a second subtitle data corresponding to the second compressed subtitle, the receiving unit receives the first compressed subtitle data and the second one of the subtitle decoding unit, and the detecting module detects and obtains an offset of the first compressed subtitle data and the second one to determine a subtitle scrolling information of the second subtitle data. It's noted that the present invention takes the compressed subtitle data as the comparing data unit, and thus the comparing time is reduced since the amount of compared data is less than the decoded subtitle stream. Besides, the playing quality and the user's reception may be higher through the elimination of the subtitle serration.

### BRIEF DESCRIPTION OF THE DRAWINGS

The invention will become more fully understood from the detailed description given herein below illustration only, and thus is not limitative of the present invention, and wherein:

FIG. 1 is a block diagram showing a real time scrolling subtitle detecting device according to a preferred embodiment of the invention;

FIG. 2 is a block diagram showing a real time scrolling subtitle detecting device according to another preferred embodiment of the invention;

FIG. 3 is a schematic diagram showing the content of the registers according to the preferred embodiment of the invention;

FIG. 4 is a flow chart showing the steps of the real time scrolling subtitle detecting device method according to a preferred embodiment of the invention; and

FIG. 5 is a block diagram showing the real time scrolling subtitle detecting device applying to a digital medium player according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

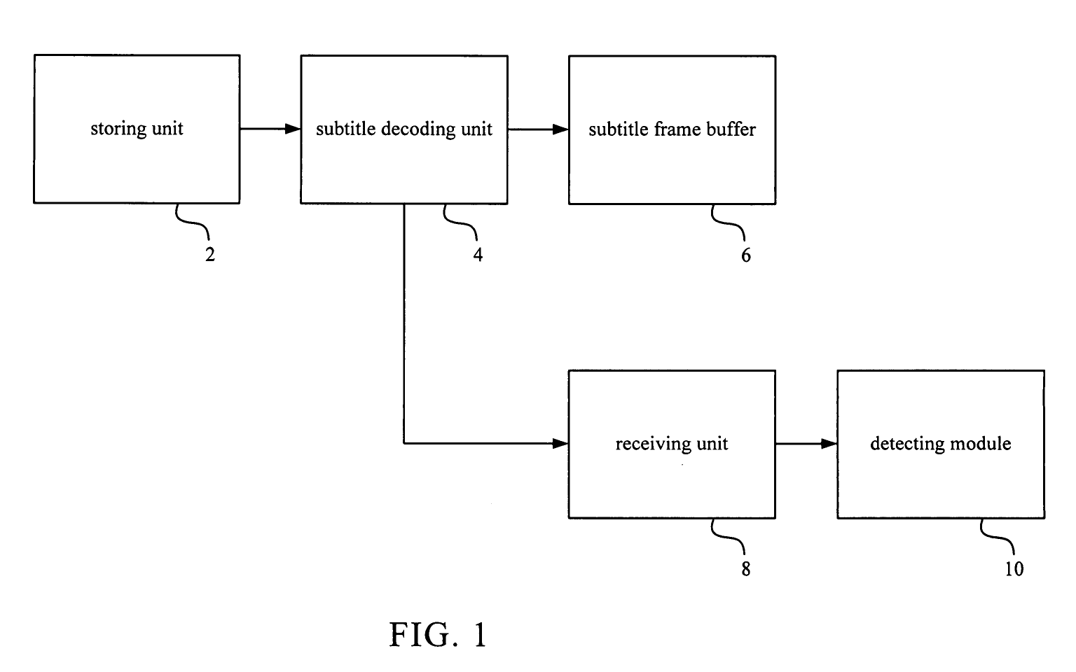

With reference to the FIG. 1, the real time scrolling subtitle detecting device of the invention includes the subtitle decoding unit 4 to decode the subtitle stream for obtaining the first compressed subtitle data and the second one, and generate the first subtitle data corresponding to the first compressed subtitle data and the second one corresponding to the second compressed subtitle, the receiving unit 8 to receive the first compressed subtitle data and the second one of the subtitle decoding unit 4, and a detecting module 10 to detect and obtain an offset of the first compressed subtitle data and the second one for determining a subtitle scrolling information of the second subtitle data.

Again, the real time scrolling subtitle detecting device of the invention further includes a storing unit 2 to provide the subtitle stream to the subtitle decoding unit 4, and a subtitle frame buffer 6 to store the first subtitle data and the second one of the subtitle decoding unit 4. Hence, the first subtitle data and the second one are provided to an overlapping unit after the detecting module 10 completing the detection of the second subtitle data.

Moreover, the first compressed subtitle data and the second one includes several lines of compressed block data, and the detecting module 10 compares the lines of compressed block data of the first compressed subtitle data and the second one for obtaining the offset and then determining the subtitle scrolling information.

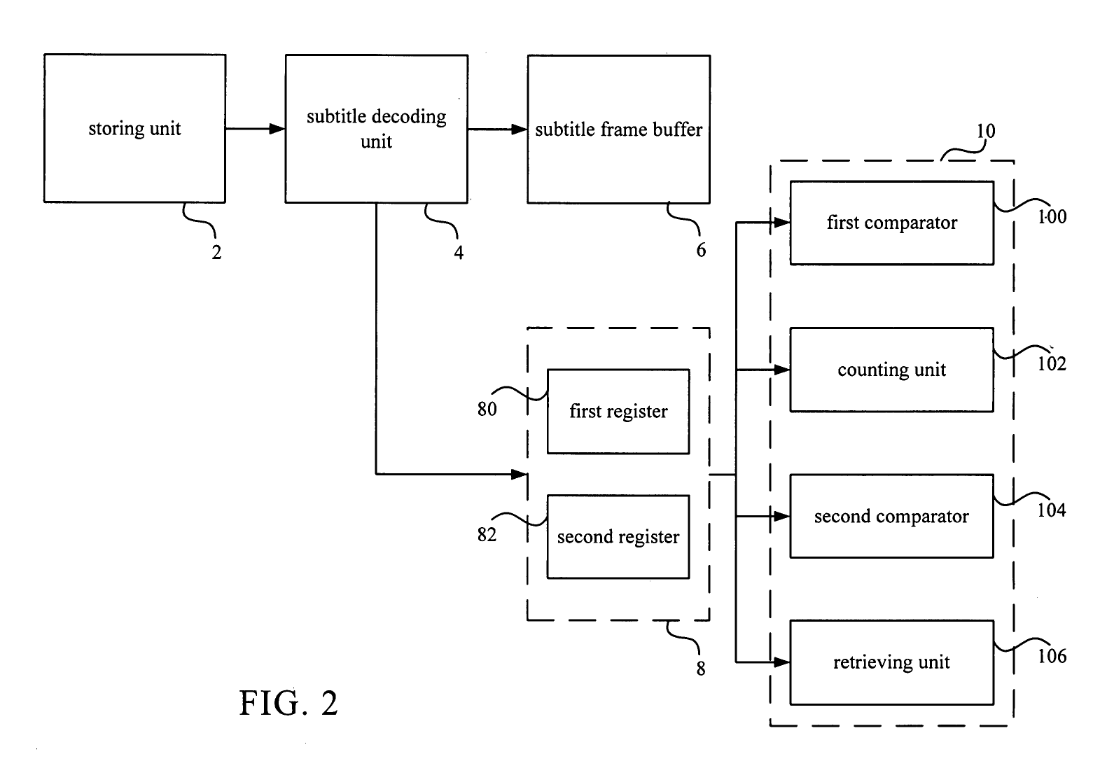

Furthermore, with reference to the FIG. 2, the block diagram shows another preferred embodiment of the real time scrolling subtitle detecting device, and herein the receiving unit 8 includes a first register 80 to store the lines of compressed block data of the first compressed subtitle data, and a second register 82 to store the lines of compressed block data of the second one, and the detecting module 10 includes a first comparator 100 to compare a start address in the first register 80 of the lines of the compressed block data of the first compressed subtitle data with the one in the second register 82 of the lines of the compressed block data of the second compressed subtitle data, a counting unit 102 having a counter for recording times of the start address in the second register 82 of the compressed block data of the second compressed subtitle data continuously equals to the one in the first register 80 of the compressed block data of the first compressed subtitle data, a second comparator 104 to compare the counter with a threshold such as four for determining whether the second subtitle data is scrolling, and a retrieving unit 106 to retrieve the start address of the compressed block data of the first compressed subtitle data while it equals to the start address of the compressed block of the second one first time as the offset, and herein the scrolling information may be scrolling up, scrolling down and amount of subtitle scrolling of the second subtitle data.

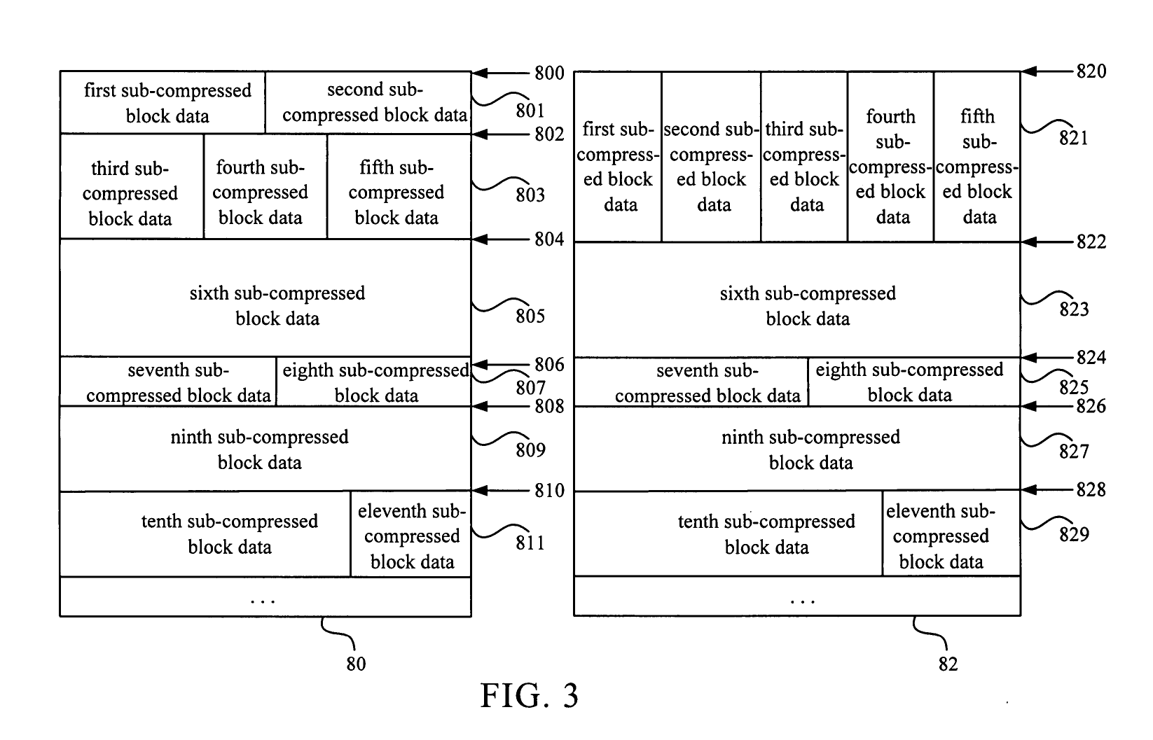

With reference to the FIG. 3, the receiving unit 8 with the first register 80 and the second register 82 stores the lines of compressed block data of the first and second compressed subtitle data of the subtitle decoding unit 4 respectively, thus the first register 80 has the first to the sixth compressed block data 801 to 811, and the second register 82 has the first to the fifth compressed block data 821 to 829. Herein, the first compressed block data 801 is stored to the 0^{th} address of the first register 80, the second one 803 is stored to the address follows the first one 801, and the rest may be deduced by analogy.

Besides, each line compressed block data includes at least one sub-compressed block data, and the subtitle decoding unit 4 decodes each sub-compressed block data of each line of first compressed block data and the second one in turn. For example, the first compressed block data 801 includes a first sub-compressed block data and a second one in this embodiment.

Moreover, With reference to the FIG. 2 and the FIG. 3, since the start address in the first register 80 of the first compressed block data of the first compressed subtitle data equals to the one in the second register 82 of the first compressed block data of the second compressed subtitle data, the counting unit 102 accumulates the counter (not shown in the FIG. 2) having a initial value “0” by 1, and then clear the counter by 0 since the start address in the first register 80 of the second compressed block data is less than the one in the second register 82 of the second compressed block data. Later, the counting unit 102 accumulates the counter by 1 since the start address in the first register 80 of the third compressed block data of the first compressed subtitle data equals to the one in the second register 82 of the second compressed block data of the second compressed subtitle data, the second comparator 104 of the detecting module 10 compares the counter with the threshold, and then compares the start address in the first register 80 of the fourth compressed block data of the first compressed subtitle data with the one in the second register 82 of the third compressed block data of the second compressed subtitle data since the counter is less than the threshold and the result is too weak to determine the scrolling information. It's noted that the rest comparison may be deduced by analogy, and the scrolling information is determined till the counter is equal to the threshold.

Accordingly, the scrolling information is determined since the counter and the threshold both are four, where the start addresses in the first register 80 of the third to the sixth compressed block data of the first compressed subtitle data equal to the one in the second register 82 of the second to the fifth compressed block data of the second compressed subtitle data respectively. In addition, the retrieving unit 106 retrieves the first matched start address as the offset, herein the offset is three in the embodiment. Moreover, the scrolling information is scrolling up since the first matched start address appears in the first register of the third compressed block data of the first compressed subtitle data and the one in the second register of the second compressed block data of the second compressed subtitle data, whereas the scrolling information is scrolling down since the first matched start address appears in the first register of the second compressed block data of the first compressed subtitle data and the one in the third register of the second compressed block data of the second compressed subtitle data.

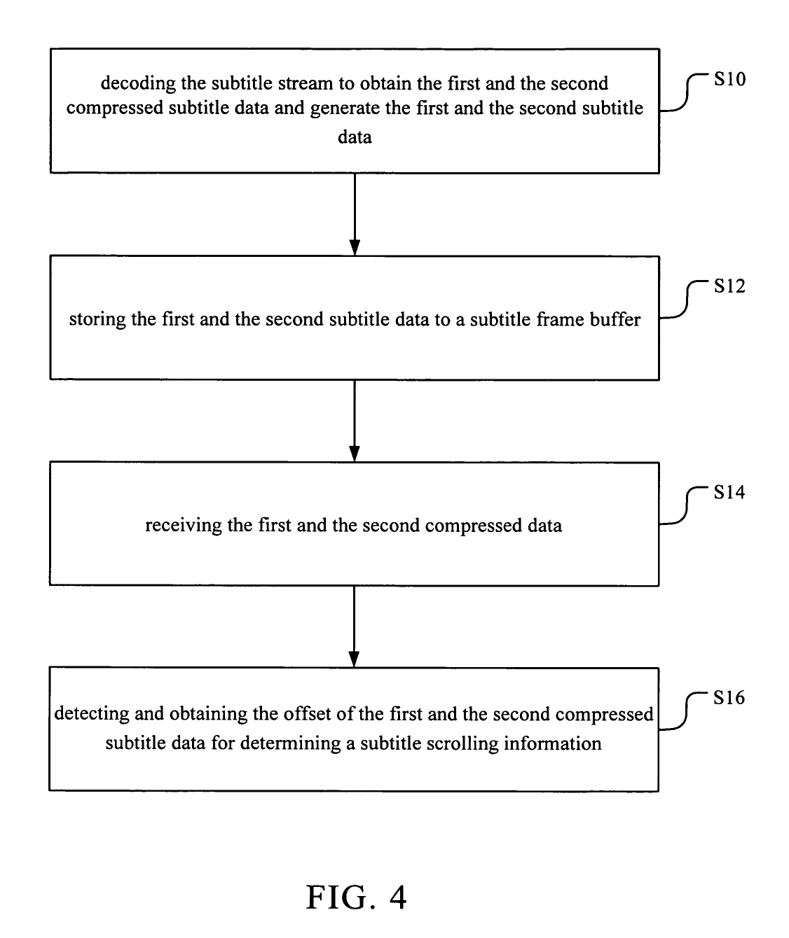

With reference to the FIG. 4, the flow chart of the real time scrolling subtitle detecting device method includes the steps of: decoding a subtitle stream to obtain a first compressed subtitle data and a second one, and generating a first subtitle data corresponding to the first compressed subtitle data and a second one corresponding to the second compressed subtitle in step S10, receiving the first compressed data and the second one of the subtitle decoding unit in step S14, and detecting and obtaining an offset of the first and the second compressed subtitle data for determining a subtitle scrolling information of the second subtitle data in step S16.

In such embodiment, the method further includes the step of storing the first and the second subtitle data to a subtitle frame buffer in step S12 after the step S10, then for an overlapping unit to overlap a first and a second video signal and the first and the second subtitle data with the subtitle scrolling information, and further outputting by a player later. In addition, the step S14 further includes the step of storing the first and the second compressed subtitle data to the first register and the second one respectively.

Moreover, the step S16 further includes the steps of: comparing a start address in the first register of the lines of the compressed block data of the first compressed subtitle data with the one in the second register of the lines of the compressed block data of the second compressed subtitle data, providing a counter to accumulate times of the start address in the second register of the compressed block data of the second compressed subtitle data continuously equals to the one in the first register of the compressed block data of the first compressed subtitle data, comparing the counter with a threshold for determining the second subtitle data is “scrolling” while they are equal to each other, and retrieving the start address of the compressed block data of the first compressed subtitle data which equals to the one of the compressed block of the second compressed subtitle data first time as the offset for determining the scrolling information.

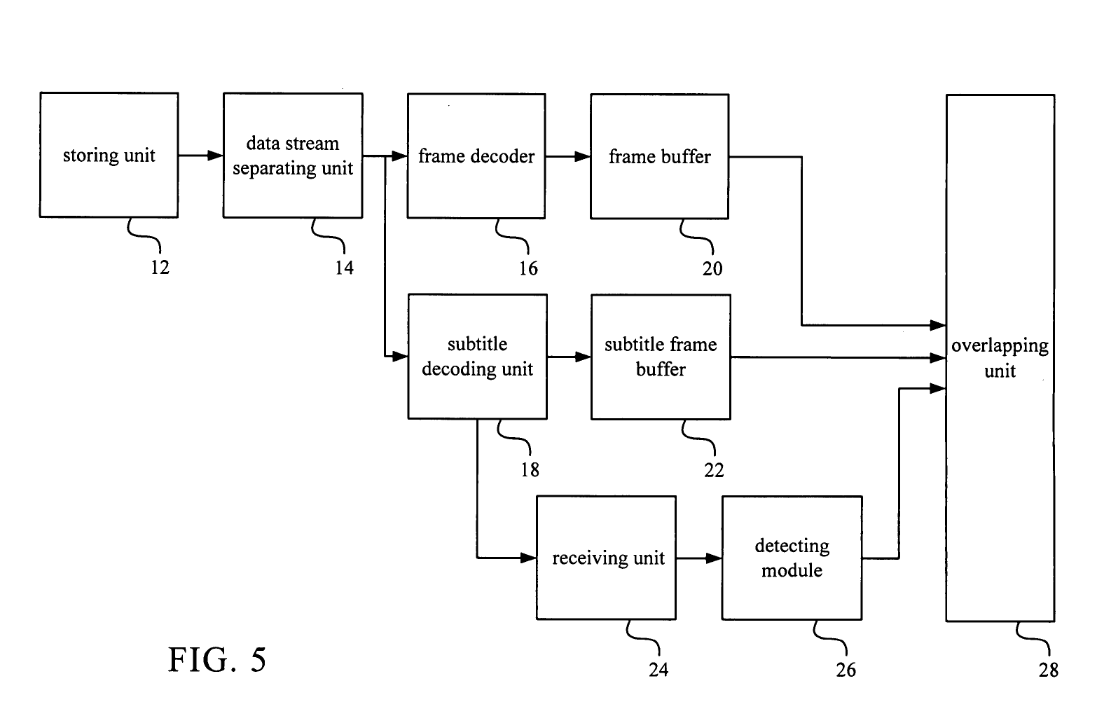

Furthermore, with reference to the FIG. 5, the digital medium player with the real time scrolling subtitle detecting device includes a storing unit 12 which provides the audio/video data with MPEG-2 and MPEG-4 encode format such as the DVD disk and the DivX file respectively, a data stream separating unit 14 which divides the audio/video data into a MPEG video stream, audio stream, and subtitle stream, a subtitle decoding unit 18 which decodes the subtitle stream to obtain the first and the second compressed subtitle data, and generating the first subtitle data corresponding to the first compressed subtitle data and the second one corresponding to the second compressed subtitle data, a subtitle frame buffer 22 which stores the first subtitle data and the second one of the subtitle decoding unit 18, a receiving unit 24 for receiving the first and the second compressed subtitle data, and a detecting module 26 which detects and obtains the offset of the first compressed subtitle data and the second one of the receiving unit 24 for determining a subtitle scrolling information of the second subtitle data.

Hence, an overlapping unit 28 is provided for overlapping a first and a second video signal decoded by a frame decoder 16 and stored in a frame buffer 20, the first subtitle data and the second one of the subtitle frame buffer 22, and the subtitle scrolling information obtained by the detecting module 26, and outputting to a display.

In addition, the detecting module 26 includes a first comparator, a counting unit, a second comparator, and a retrieving unit. The functionality of each component may be deduced by analogy and be referred to the embodiment shown in the FIG. 2.

Besides, the real time scrolling subtitle detecting device and method maybe implemented in either firmware or hardware.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A real time scrolling subtitle detecting device, comprising:
a subtitle decoding unit for decoding a subtitle stream to obtain a first compressed subtitle data and a second compressed subtitle data, and generating a first subtitle data corresponding to the first compressed subtitle data and a second subtitle data corresponding to the second compressed subtitle data;
a receiving unit for receiving the first compressed subtitle data and the second compressed subtitle data of the subtitle decoding unit; and
a detecting module for detecting and obtaining an offset of the first compressed subtitle data and the second compressed subtitle data for determining a subtitle scrolling information of the second subtitle data.

2. The device of claim 1, further comprising:
a subtitle frame buffer for storing the first subtitle data and the second subtitle data of the subtitle decoding unit.

3. The device of claim 2, further comprising:
an overlapping unit for overlapping a first video signal with the first subtitle data and a second video signal, and the second subtitle data with the subtitle scrolling information.

4. The device of claim 1, wherein the receiving unit further comprises:
a first register for storing a plurality lines of compressed block data of the first compressed subtitle data in turn; and
a second register for storing a plurality lines of compressed block data of the second compressed subtitle data in turn.

5. The device of claim 4, wherein the detecting module further comprises:
a first comparator for comparing a start address in the first register of a plurality lines of the compressed block data of the first compressed subtitle data with a start address in the second register of a plurality lines of the compressed block data of the second compressed subtitle data;
a counting unit having a counter for recording times of the start address in the first register of a plurality lines of the compressed block data of the first compressed subtitle data continuously equals to the start address in the second register of a plurality lines of the compressed block data of the second compressed subtitle data;
a second comparator for comparing the counter with a threshold for determining whether the second subtitle data is scrolling; and
a retrieving unit for retrieving the start address of the compressed block data of the first compressed subtitle data while it equals to the start address of the compressed block of the second compressed subtitle data first time as the offset.

6. The device of claim 5, wherein the threshold is four at least.

7. The device of claim 1, wherein the subtitle scrolling information is scrolling up.

8. The device of claim 1, wherein the subtitle scrolling information is scrolling down.

9. The device of claim 1, wherein the subtitle scrolling information is an amount of subtitle scrolling of the second subtitle data.

10. The device of claim 1, further comprising:
a storing unit for providing the subtitle stream.

11. The device of claim 1, wherein the real time subtitle scrolling detecting device applies to a medium player.

12. A real time subtitle scrolling detecting method, comprising:
decoding a subtitle stream to obtain a first compressed subtitle data and a second compressed subtitle data, and generating a first subtitle data corresponding to the first compressed subtitle data and a second subtitle data corresponding to the second compressed subtitle;
receiving the first compressed data and the second compressed data; and
detecting and obtaining an offset of the first compressed subtitle data and the second compressed subtitle data for determining a subtitle scrolling information of the second subtitle data.

13. The method of claim 12, further comprising:
storing the first subtitle data and the second subtitle data to a subtitle frame buffer.

14. The method of claim 12, further comprising:
storing a plurality lines of compressed block data of the first compressed subtitle data to a first register in turn; and
storing a plurality lines of compressed block data of the second compressed subtitle data to a second register in turn.

15. The method of claim 12, the step of detecting the first compressed subtitle data and the second compressed subtitle data further comprising:
comparing a start address in the first register of a plurality lines of the compressed block data of the first compressed subtitle data with a start address in the second register of a plurality lines of the compressed block data of the second compressed subtitle data;
providing a counter to accumulate times of the start address in the second register of the compressed block data of the second compressed subtitle data continuously equals to the start address in the first register of the compressed block data of the first compressed subtitle data;
comparing the counter with a threshold for determining the second subtitle data is scrolling while the counter equals to the threshold; and
retrieving the start address of the compressed block data of the first compressed subtitle data which equals to the start address of the compressed block of the second compressed subtitle data first time as the offset.
